(19) United States
(12) Patent Application Publication
(10) Pub. No.: US 2006/0161442 A1
(43) Pub. Date: Jul. 20, 2006

(54) System and method for analyzing or identifying customer requirements

(76) Inventors: Susanne Laumann, Nurnberg (DE); Thorsten Koopmann, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/036,308

(22) Filed: Jan. 14, 2005

(51) Int. Cl. G06Q 99/00

(52) U.S. Cl. 705/1

(57) ABSTRACT

A method or system is provided for analyzing or identifying customer requirements. The identified requirements may be used to design a product family or redesign a process. The product can be, but is not necessarily, a computer program. For the analysis or identification, a master diagram is used in which time is defined along a first axis and a plurality of different information systems or alternatively stakeholders, user groups, or user types, are defined along a second axis, the diagram illustrating a plurality of case types, also known as tasks or task types, applicable for the product family or available solutions. By use of the master diagram, a variation diagram is created having the same first and second axes as the master diagram in which only case types are illustrated which are relevant for a particular program product being designed for example, and a position of each relevant case type relative to the first axis defines a particular time at which the relevant case type occurs relative to the other relevant case types. For each of the relevant case types of the variation diagram, an automization versus functionality diagram is defined. The aforementioned variation. diagram and automization versus functionality diagram are then used for analyzing or identifying the customer requirements. These identified requirements may be used to create a particular software program product of a product family.

### BACKGROUND

The present application relates to a system and/or method for analyzing or identifying customer requirements.

For a particular field of business, it is known for automating or improving the business of customers in that particular business field to analyze or identify customer requirements for the operation of their business. These identified requirements may be used, for example, to consult with the customer to improve his business methods, or, for example, to develop a variety of software products to automate the business. Since the needs of various customers within the business field can vary substantially, the development of the various software products to satisfy the needs of the various customers is a difficult and laborious process because of the many differences between the various customers. Also, even for a particular customer, the needs may vary widely within the different groups or departments of that particular customer.

The present patent application is not limited to any particular field of business. However, for exemplary purposes and in view of the preferred embodiment disclosed hereafter, the business field selected as exemplary is the field of medical imaging. However, this is only exemplary and the present application relates to any business field involving the analyzing or identifying of customer requirements which may be used for consulting, or for development of a family of products such as software.

As shown in prior art FIG. 1, for the field of medical imaging, there are various types of medical imaging overlapping market segments. Because of this variety of overlapping market segments, a large family of software products is necessary to service the entire business field. This business field, of course, is made up of a large number of different types of customers, each with different needs and requirements (so-called “customer requirements”).

As shown in FIG. 1, the medical imaging market 10, by way of example only, may have at least four general overlapping market segments 11-14. More specifically, there may be a market segment automation sophistication level (product cost) 11 where the sophistication or cost may be high 11A, medium 11B, or low 11C. Another market segment 12 which may overlap with market segment 11 are the different types of imaging customers such as an imaging center 12A or a university hospital 12B. In market segment 13 representing different specialties, there may be cardiology diagnostic imaging 13A or radiology diagnostic imaging 13B. In market segment 14 representing different types of imaging there may be x-ray imaging 14A, computer tomography 14B, ultrasound 14C, or magnetic resonance 14D. As is known to those skilled in the art, various types of overlap of these marketing segments in different combinations may occur. This makes a systematic identification or analyzing of customer requirements, such as may be needed for consulting or for the design of a family of software products extremely complicated.

It was known in the prior art to conduct what are known as “user case” interviews at each customer. In this known process, the entity or company which is analyzing or identifying customer requirements, such as for consulting or developing a family of software products, is herein known as the “developer”. Typically the developer has a team of analysts who travel to the different customers and interview persons involved in each step of the business methods being employed at the particular customer. As a result of these interviews, it is known to create what are known as “use cases”. These use cases represent the typical day in the life of the person being interviewed, and include a report of that person's typical daily activities. For example, it might be the typical day for a receptionist who schedules appointments for radiology. It is known that these so-called “use cases” can be grouped into “use case types”. Thus, if a plurality of receptionists were interviewed at a given hospital, a plurality of use case reports would be generated falling under the same use case type—“schedule appointment”, for example. Another use case type might be for example “order request” where the request for a radiology imaging is requested.

Although the term “customer” is used herein, the word should be understood to be very broad and encompasses any entity for whom consulting services are being performed or a software product or products are being developed.

It was known to provide the use case reports generated by the analysts to the consultants and/or to programmers for the developer. The programmers then would assimilate all of these different use cases in an attempt to write one or more software products, or would use the information for consulting. Although the programmer may attempt to write a somewhat generic software program product to satisfy more than one customer or the needs of different groups or departments for a particular customer, the task is extremely difficult in view of the very large number of use cases and the great variation between use cases. Even though it was known in the prior art to group use cases under a particular use case type, this was extremely difficult. Also if other divisions of the same developer had programmers writing software products for one portion of the product family and other programmers writing software products for other parts of the product family, severe communication problems existed between the programming groups resulting in a “hodgepodge” creation of software products in an attempt to develop a family. Conflicts would arise in the prior art between the different software products developed by those different software groups within the same developer company. Also, changes requested by one customer may adversely affect products created for other customers.

### SUMMARY

It is an object to provide a method and/or system which will simplify the identification and/or analysis of customer requirements (customer needs), such as for consulting and/or for development of a family of products such as software, in a business market having different and possibly overlapping market segments.

In a method or system for analyzing or identifying customer requirements, a plurality of case reports from a plurality of entities who may be serviced are created. With the case reports, a master diagram is created in which time is defined along a first axis and a plurality of different information systems, or alternatively stakeholders, user groups, or user types, are defined along a second axis, said diagram illustrating a plurality of case types, also known as case tasks or task types, applicable for the product family or available solutions. By use of the master diagram, a variation diagram is created having the same first and second axes as the master diagram in which only case types are illustrated which are relevant for a particular program product being designed or a particular solution, for example, and a position of each relevant case type relative to the first axis defines a particular time at which the relevant case type occurs relative to the other relevant case types. For each of the relevant case types of the variation diagram, an automization versus functionality diagram is defined. The aforementioned variation diagram and automization versus functionality diagram are then used for analyzing or identifying the customer requirements.

### BRIEF DESCRIPTION OF THE DRAWINGS

FIG. 1 is a prior art block diagram showing overlapping market segments in the business field of medical imaging;

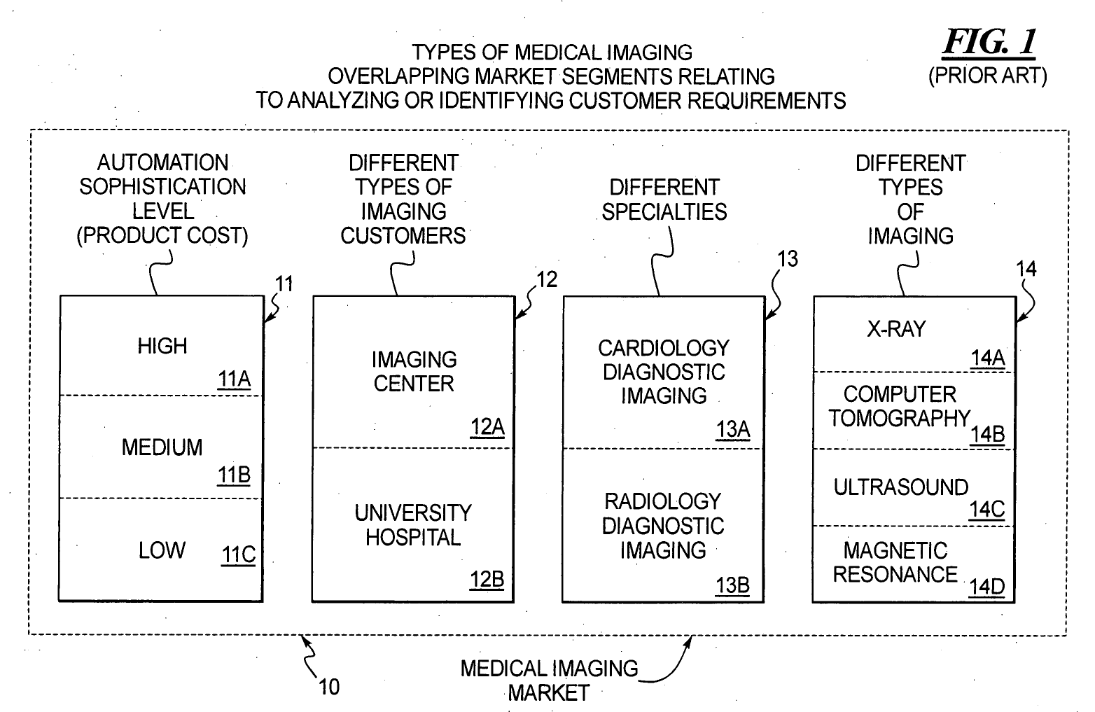

FIG. 2 is a block diagram showing the use of a computer with a customer requirements analysis or identification program to assist in consulting, and/or for the development of a family of software products, based on use case reports received from a plurality of customers;

FIG. 3 is an idealized master template diagram of the customer requirements analysis or identification program of FIG. 2;

FIG. 4 is an emergency room variation diagram based on the idealized master template diagram of FIG. 3;

FIG. 5 is an ultrasound variation diagram based on the idealized master template diagram of FIG. 3;

FIG. 6 is an automization versus functionality diagram showing. a possible profile based on certain selected use case types of FIG. 3 indicating a selection of functionality verses automization as designated by the user of the program of FIG. 2 in the case of an imaging center example; and

FIG. 7 is similar to FIG. 6 but shows the possible profile of a university hospital and the user designation of automization versus functionality with the program of FIG. 2.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

Again it is stressed that only a preferred embodiment relating to the medical imaging business field is described herein. However, the present invention may relate to any business field.

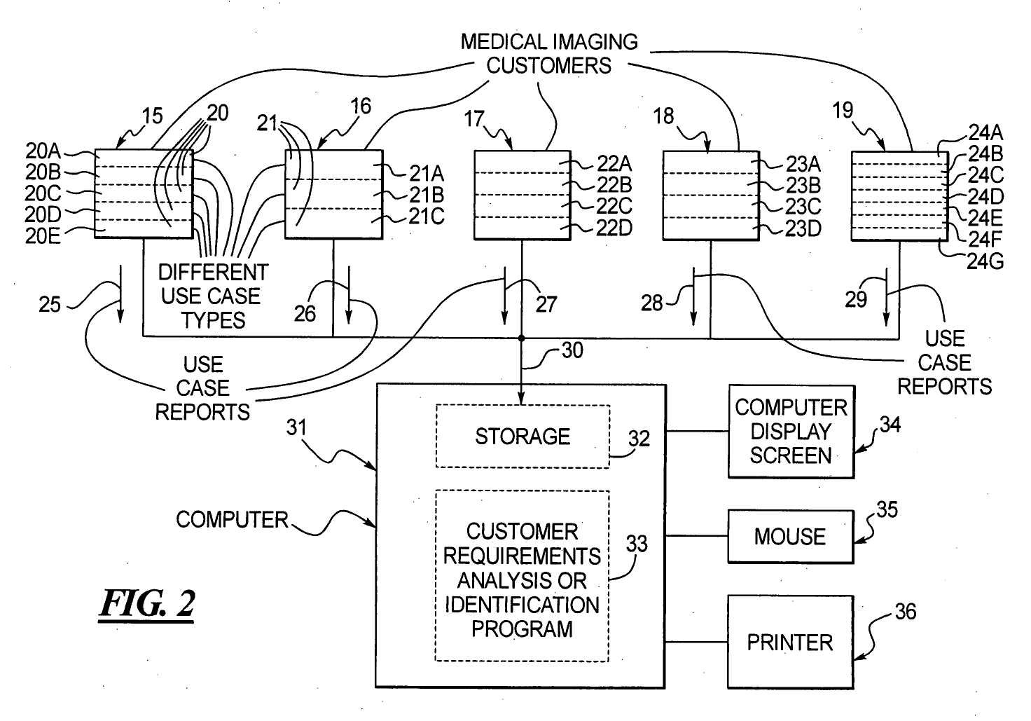

Referring to the block diagram of FIG. 2, a plurality of different medical imaging customers 15-19 having different needs and desires and different types of groups and departments are illustrated. For example, for medical imaging customer 15, five different use case types (that is, for example, five different steps) in the business process for that particular customer 20A-20E may be involved. The term “use case type” also means tasks or types of tasks. For use case type 20A, for example, one or more persons may be interviewed to develop one or more use cases for that particular use case type 20A. The same would be true of use case types 20B-20E. Thus a plurality of use case report groups 25 are generated. Similarly for customer 16 having for example three use case types 21A-21C, a plurality of use case report groups 26 are generated. The same is true of customers 17, 18 and 19 where respective use case types 22A-22D, 23A-23D, and 24A-24G are involved generating respective use case report groups 27, 28, and 29.

At input 30 to computer 31, the use case report groups 25-29 are input where they may be stored in storage 32.

The computer 31 has a customer requirements analysis or identification program 33 for use in consulting with a specific customer to improve that customer's business operations, and/or for use in designing as part of a software product family specific software system products for a specific customer. Computer 31 has associated therewith a computer display screen 34 as an output device, mouse 35 as an input device, and printer 36 as another output device. The user, for example by use of mouse 35, can click on various portions of various screen displays displayed on computer display screen 34. By this process, the programmer for the developer can assemble pertinent information, such as flow chart or other diagram displayed information, for consulting or for the development of a particular software product within the software product family for a particular customer. That software product developed by the programmer may in fact even be for a particular department or group of a particular customer. Alternatively, the programmer has the ability to create flow chart information by use of the program 33 useful for developing a product for a particular customer for use by a plurality of groups or departments of that particular customer.

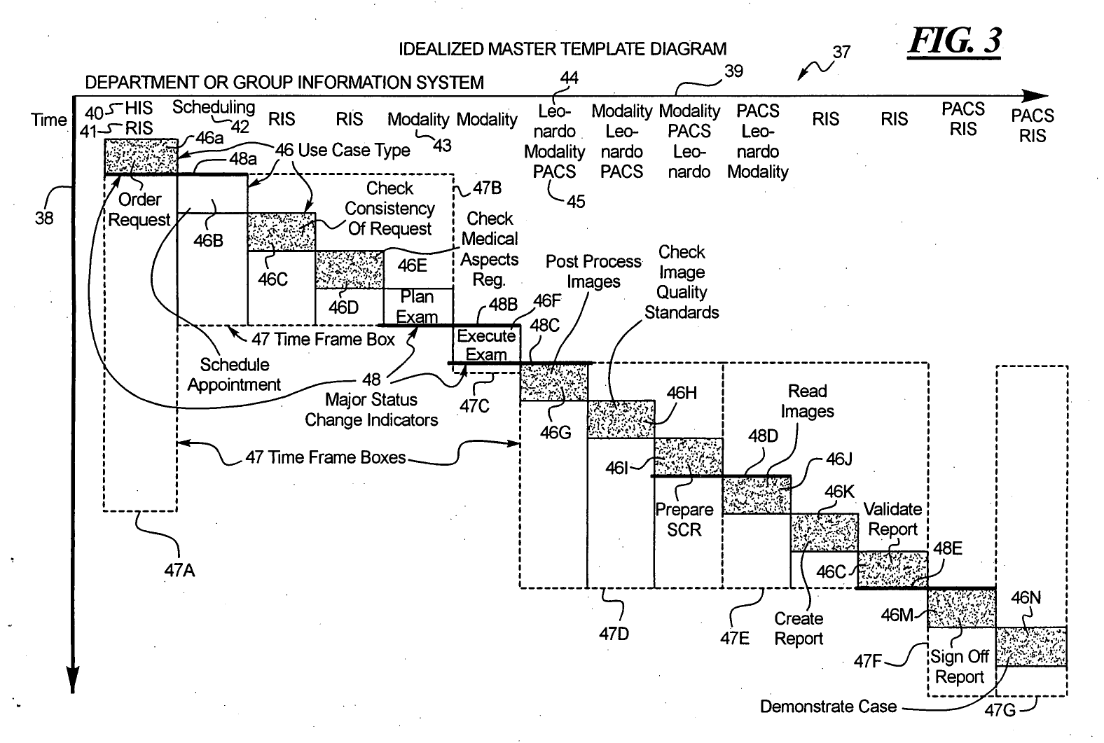

Although a computer 31 is shown, the diagrams described hereafter and shown in FIGS. 3-7 may also be created manually.

As shown in FIG. 3, an idealized master template diagram 37 is preferably displayed as a window or screen on the computer display screen 34 when running the product family design program 33 on computer 31. Preferably this is one of the first steps taken by the user (developer programmer) of the program.

The idealized master template diagram is created using the use case reports either manually or by the computer 31. The diagram 37 illustrates on its vertical axis 38 time, and on its horizontal axis 39 the various information (IT) systems. Alternatively, instead of information systems, stakeholders, user groups, or user types may be displayed along axis 39. The term “stakeholders” means an individual having an interest in a particular task. In FIG. 3. a total of six information systems 40-45 are shown on the horizontal axis—namely HIS 40 (Hospital Information System), RIS 41 (Radiology Information System), scheduling information system 42, modality information system 43, Leonardo information system 44, and PACS information system 45 (Picture Archival Communication System). For example, the modality information system 43 is involved in the use case type 46E planning the imaging exam, executing the imaging exam (use case type 48B), close processing images at use case 46G, checking image quality standards—use case type 46H, prepare SCR—use case type 46I, and read images—use case type 46J.

In master template diagram 37, as previously indicated the vertical axis 38 represents time. In other words, the use case type depending on the situation, may occur at different times in the workflow process depending upon the customer and/or group or department for that individual customer.

The dashed line time frame boxes 47 represent the range of times within which the use case type may occur within the entire product family. Such different time frame boxes 47A-47G are illustrated.

The solid black lines indicated by 48 are major status change indicators such as 48A-48R. These. indicate a major status change in the idealized process or business workflow. For example, a major status change occurs between scheduling and planning the examination and the actual execution of the examination—compare boxes 47B and 46F.

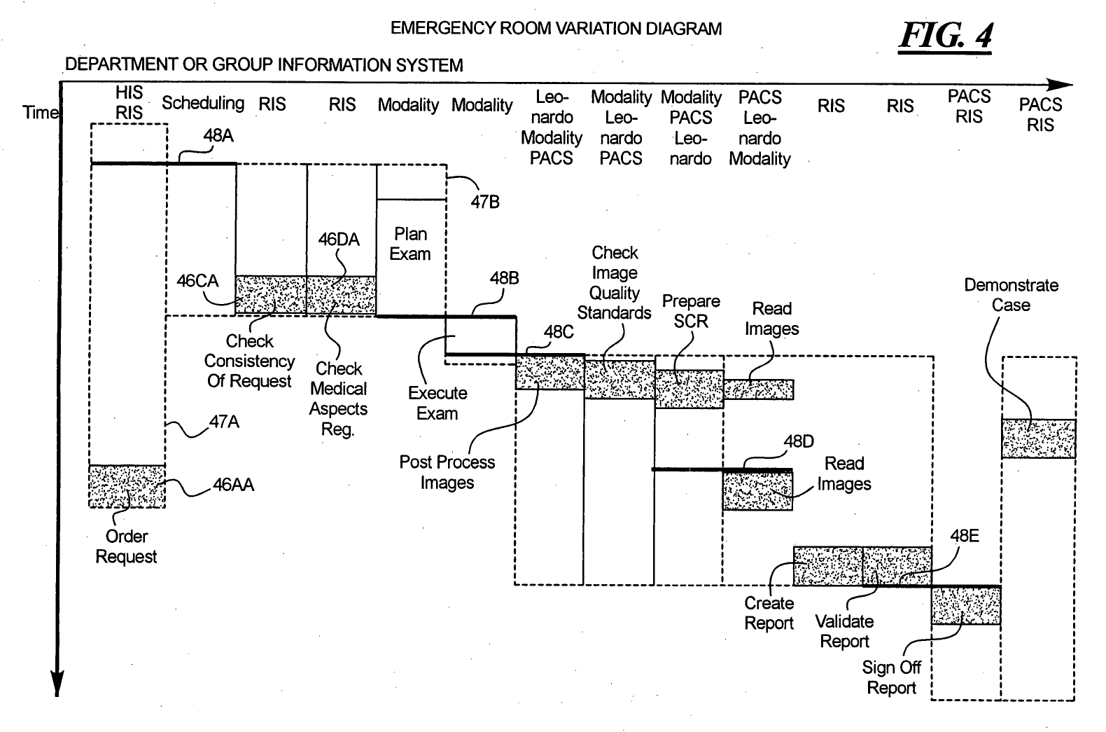

Finally, it is noted that in FIG. 3 with the idealized master template 37, a continuous stair step pattern is created with each step of the workflow relating to the entire product family occurring in sequence. In the real world, however, depending on the particular customer software product being designed, this is usually not the case. See for example FIG. 4 (the emergency room variation diagram) showing how the time at which the various use case types occur can change within the time frame boxes. For example, the order request use case type 46AA occurs much later in time for the emergency room variation diagram. In other words, in an emergency situation, the patient would first have medical aspects checked and the examination executed on an emergency basis, with the order request actually being processed later as shown by 46AA. In the emergency room variation diagram of FIG. 4, it is also noted that there is no use case type relating to “schedule appointment” since if an emergency occurs, there is no appointment to be scheduled. Finally, it is noted, for example, that the checking consistency of the request box 46AA and checking the medical aspects request box 46DA occur later in time than in the case of the idealized master template diagram 37.

By way of further example, the variations for an ultrasound imaging variation diagram are illustrated where it can be seen that the use case types 46BA, 46CB, and 46DB, have changed position—that is occurred at a different time—as indicated in the idealized master template diagram 37.

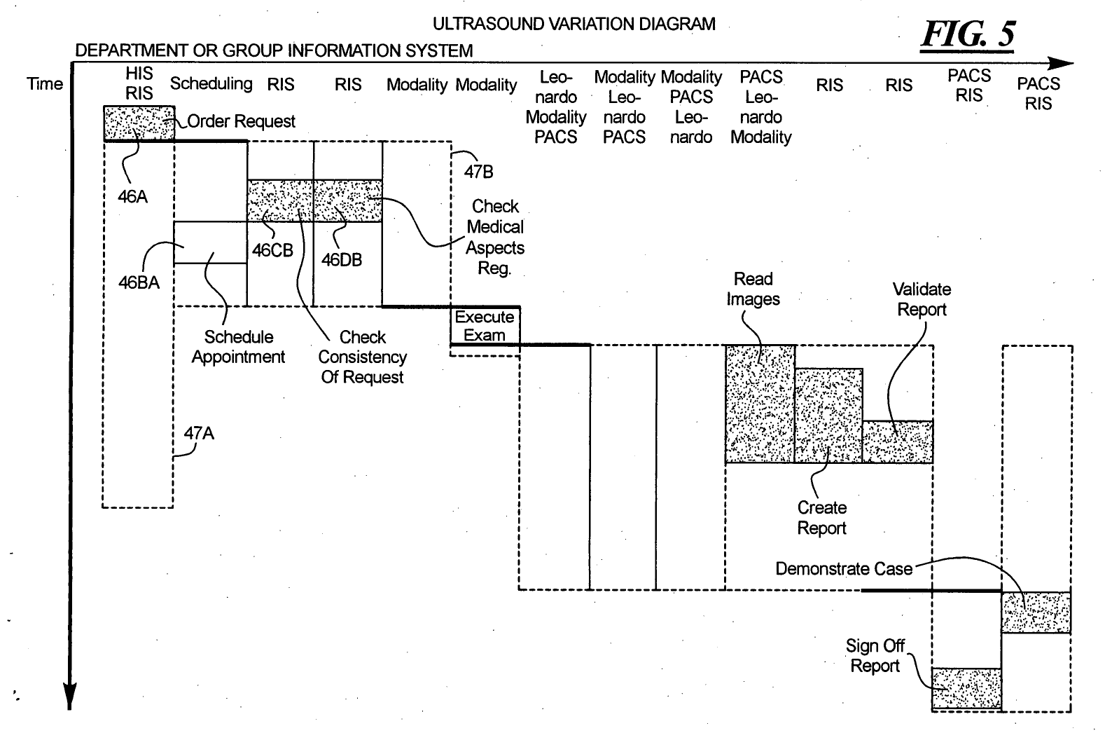

The variation diagrams of FIGS. 4 and 5 are created manually or by computer by use of the master template diagram and the use case reports.

When the programmer is running the customer requirements analysis or identification program 33, he first initially creates the idealized master template diagram 37 from the use case reports. As a next step, the programmer or consultant creates manually or with the computer a variation diagram (such as FIGS. 4 and 5), for which he is consulting or designing a product, from the master template diagram and the use case reports.

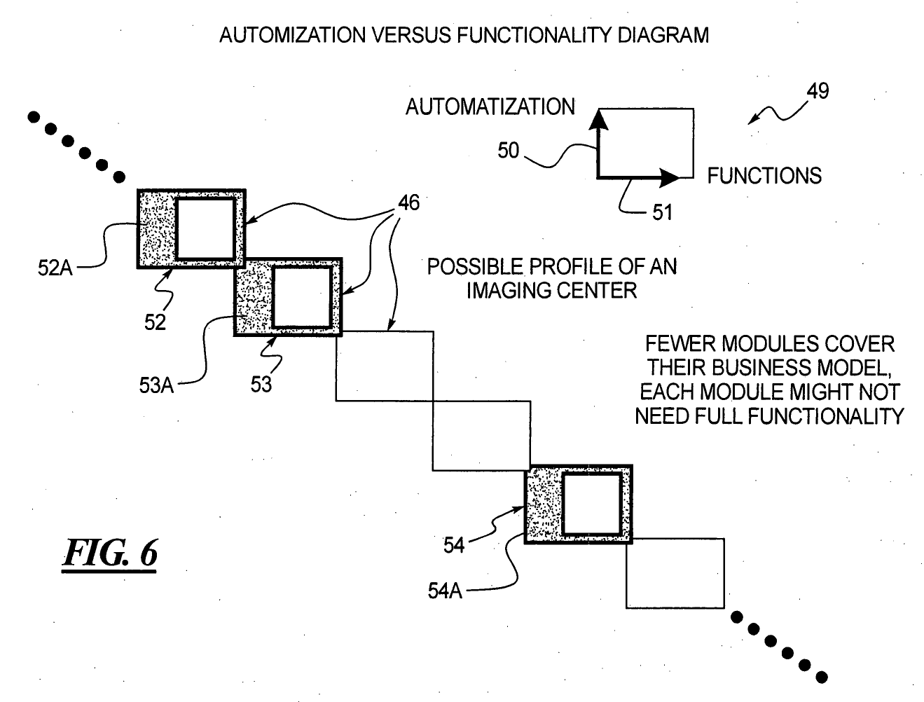

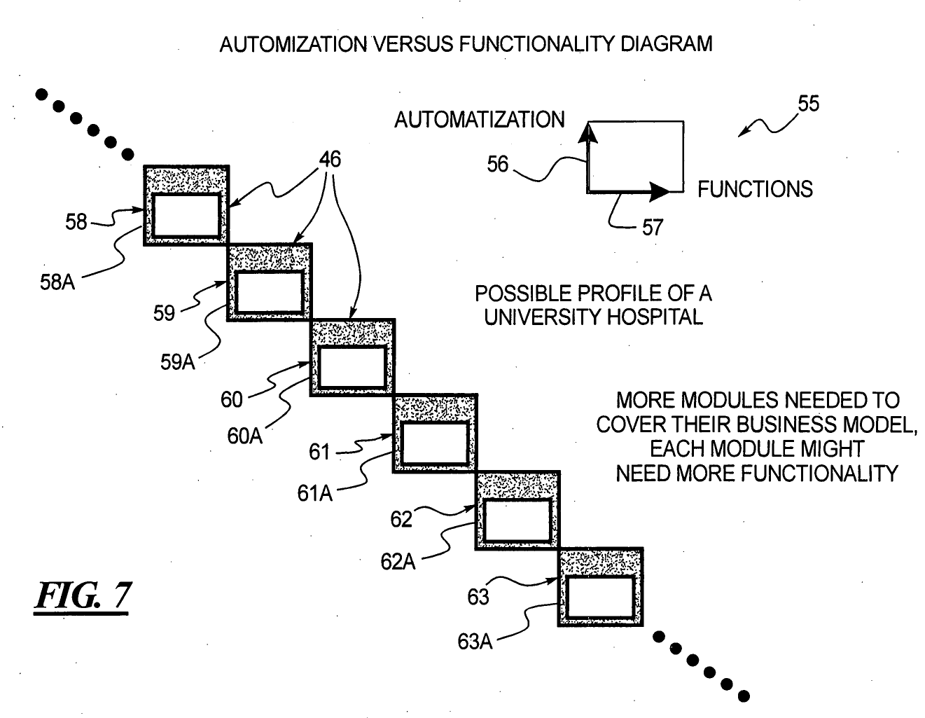

When the programmer or consultant has completed these tasks, the programmer or consultant then creates with the computer, or manually, another diagram from the variation diagram and the use case reports and known as the “automization versus functionality diagram” exemplified in FIGS. 6 and 7. As shown at 49 in FIG. 6, a possible profile of an imaging center is illustrated where in a portion of the stair step flow of the master template diagram the particular relevant use case types have been highlighted. Here, three such use case types have been highlighted along the stair step use case type flow. Each of these use case types may also be known as “modules” which could be portions of the overall software program product to be created by the programmer. Within each one of these use case types or modules, the programmer has a choice to decide for that particular use case type whether all or less than all functions are to be selected and the extent of automization for the selected functions. This is illustrated by the vertical arrow 50 titled “automization” and by the horizontal arrow 51 titled “functions”.

The functions are listed along the horizontal axis at 51 are taken from the use case reports for the particular relevant use case type for which the profile is being created. The extent of automization on the vertical axis at 50 may, for example, be indicated as 0 to 100%.

In FIG. 6, fewer modules are covering the business model and where each module might not need full functionality. This is indicated at selected (highlighted) use case types 52, 53, and 54 by the respective blackened regions 52A, 53A, and 54A showing selection of only a few functions but maximum automization for those few selected functions. This might be the case, for example, for a customer, which is an imaging center.

On the other hand, for a university hospital customer as shown in FIG. 7, more modules are needed to cover the business model and each module might need more functionality. This is illustrated by use case types 58-63 all being highlighted or illuminated on the display screen of the computer and by blackened areas 58A-63A showing complete functionality being selected for each of the use case types, but with a lower level of automization for each of those selected functions.

As a result of the aforementioned diagram creations by the programmer with the customer requirements analysis or identification program 33, the diagrams themselves or information based on the diagrams such as a flow chart for a particular customer software product being designed may be output on screen 34 or printer 36. The programmer or consultant may then use the flow chart information or the diagrams themselves to identify and/or analyze the customer requirements, and/or to write the particular software program product for the particular customer.

By use of the aforementioned program tool identifying customer requirements, different programmers in different departments of the developer company can write particularized program products which will fit within an overall family of software products. Thus, particularized software products developed by different programmers in different parts of the company will interface with each other and result in a family of software products where conflicts. have been substantially reduced. Also, the programming time by the programmer has been substantially reduced by use of the program tool.

While a preferred embodiment has been illustrated and described in detail in the drawings and foregoing description, the same is to be considered as illustrative and not restrictive in character, it being understood that only a preferred embodiment has been shown and described and that all changes and modifications that come within the spirit of the invention both now or in the future are desired to be protected.

We claim as our invention:

1. A method for analyzing or identifying customer requirements, comprising the steps of:
creating a plurality of use case reports from a plurality of customers;
creating from the use case reports a master template diagram in which time is defined along a first axis and a plurality of at least one of information systems, stakeholders, user groups, and user types are defined along a second axis, said master template diagram illustrating a plurality of use case types applicable for a plurality of market segments corresponding to said plurality of customers;
by use of at least the master template diagram and use case reports, creating a variation diagram having the same first and second axes as the master template diagram in which only use case types are illustrated which are relevant for a specific customer requirements analysis or identification, and a position of each relevant use case type relative to the first axis defines a particular time at which the relevant use case type occurs relative to the other relevant use case types;
for each of the relevant use case types of the variation diagram, creating an automization versus functionality diagram by use of the variation diagram and the use case reports; and
utilizing information from the variation diagram and automization versus functionality diagram to analyze or identify requirements of said specific customer.

2. A method of claim 1 wherein the customers relate to the medical imaging business field.

3. A method of claim 1 wherein a computer is used to create the master template, variation, and automization versus functionality diagrams.

4. A method of claim 1 wherein the master template diagram comprises an idealized master template for an entire product family.

5. A method of claim 1 wherein the master template diagram comprises a stair step arrangement of said use case types for a product family such that each successive use case type follows in time after a preceding use case type.

6. A method of claim 1 wherein the master template diagram comprises time frame boxes representing a range of times for use case types located within the respective time frame box.

7. A method of claim 1 wherein the master template diagram has at least one boundary representing a major status change between use case types.

8. A method of claim 7 wherein said boundary comprises a solid line.

9. A method of claim 1 wherein the master template diagram has dashed line time frame boxes.

10. A method of claim 1 wherein the identified requirements are used to design a particular software program product of a product family for a particular customer.

11. A method of claim 1 wherein the diagrams are utilized to create a particular program product of a software product family.

12. Method of claim 1 wherein said use case reports comprise information relating to a typical day of at least one individual associated with each use case type.

13. A method for analyzing or identifying entity requirements, comprising the steps of:
creating a plurality of case reports from a plurality of entities who may be serviced by the analysis or identification of entity requirements;
creating from the case reports a master template diagram in which time is defined along a first axis and a plurality of at least one of information systems, stakeholders, user groups, and user types are defined along a second axis, said master template diagram illustrating a plurality of case types corresponding to said plurality of entities;
creating a variation diagram based in part on the master template diagram in which only case types are illustrated which are relevant for a specific requirements analysis or identification, and a position of each relevant case type relative to the first axis defines a particular time at which the relevant case type occurs;
for at least one of the relevant case types of the variation diagram, creating an automization versus functionality diagram; and
utilizing information from the variation diagram and automization versus functionality diagram to analyze or identify entity requirements.

14. A system for analyzing or identifying customer requirements, comprising:
a plurality of use case reports from a plurality of customers;
a master template diagram in which time is defined along a first axis and a plurality of at least one of information systems, stakeholders, user groups, and user types are defined along a second axis, said master template diagram illustrating a plurality of use case types applicable for a plurality of market segments corresponding to said plurality of customers;
a variation diagram having the same first and second axes as the master template diagram in which only use case types are illustrated which are relevant for a specific customer requirements analysis or identification, and a position of each relevant use case type relative to the first axis defining a particular time at which the relevant use case type occurs relative to the other relevant use case types;
an automization versus functionality diagram for each of the relevant use case types of the variation diagram; and
the variation diagram and automization versus functionality diagram having information useful to analyze or identify requirements of said specific customer.

15. A system of claim 14 wherein the customers relate to the medical imaging business field.

16. A system of claim 14 wherein a computer is used to create the master template, variation, and automization versus functionality diagrams.

17. A system of claim 14 wherein the master template diagram comprises an idealized master template for an entire product family.

18. A system of claim 14 wherein the master template diagram comprises a stair step arrangement of said use case types for a product family such that each successive use case type follows in time after a preceding use case type.

19. A system of claim 14 wherein the master template diagram comprises time frame boxes representing a range of times for use case types located within the respective time frame boxes.

20. A system of claim 14 wherein the master template diagram has at least one boundary representing a major status change between use case types.

21. A system of claim 20 wherein said boundary comprises a solid line.

22. A system of claim 20 wherein the master template has dashed line time frame boxes.

23. A system of claim 14 wherein the identified requirements are used to design a particular software program product of a product family for a particular customer.

24. A system of claim 14 wherein the diagrams are utilized to create a particular program product of a software product family.

25. A program of claim 14 wherein said use case reports comprise information relating to a typical day of at least one individual associated with each use case types.

26. A system for analyzing or identifying entity requirements, comprising:
a plurality of case reports from a plurality of entities;
a master template diagram in which time is defined along a first axis and a plurality of at least one of information systems, stakeholders, user groups, and user types are defined along a second axis, said master template diagram illustrating a plurality of case types applicable for a plurality of market segments corresponding to said plurality of entities;
a variation diagram based in part on the master template diagram in which only case types are illustrated which are relevant for a specific requirements analysis or identification, and a position of each relevant case type relative to the first axis defining a particular time at which the relevant case type occurs;
an automization versus functionality diagram for at least one of the relevant case types of the variation diagram; and
the variation diagram and automization versus functionality diagram having information useful to analyze or identify entity requirements.
